(19) United States
(12) Patent Application Publication
(10) Pub. No.: US 2004/0034788 A1
(43) Pub. Date: Feb. 19, 2004

(54) Intellectual property protection and verification utilizing keystroke dynamics

(76) Inventor: Gordon Alfred Ross, Bellevue, WA (US)

Correspondence Address: Mr. Gordon A. Ross, B-203 13858 NE 8th St., Bellevue, WA, 98008-5204, US

(21) Appl. No.: 10/219,655

(22) Filed: Aug. 15, 2002

(51) Int. Cl. G06F 12/14

(52) U.S. Cl. 713/193; 380/281; 713/179

(57) ABSTRACT

This process for biometric intellectual property protection and verification uses the science of combining “keystroke dynamics” and a “copy protection key” generated by this keystroke dynamic methodology and embedding it into intellectual property to prevent unauthorized licensors or persons from accessing copy-protected intellectual property or documents. As the “authorized licensor's or person's protection key” is typed or entered, timing measurements taken between each keystroke or character input are applied to define a “biometric signature” or “template” of the authorized licensor or person. This “signature or template” is then embedded into the intellectual property and would require the proper signature to access the intellectual property “as defined” by the owner of the intellectual property. These timing factors are calculated, measured, and attached to the definition of the “intellectual property protection key”.

A portion of the disclosure of this patent document contains material, which is subject to (copyright or mask work) protection. The (copyright or mask work) owner has no objection to the facsimile reproduction by any one of the patent document or the patent disclosure, as it appears in the Patent and Trademark Office patent file or records, but otherwise reserves all (copyright or mask work) rights whatsoever.

This invention relates to intellectual property protection in the digital medium. More specifically, this invention pertains to a new method of protecting digital data against unauthorized copying, access and use.

Digital media and data have become popular means of distributing intellectual property. Computer software, data files, video files and audio information, for instance, are widely available on various digital storage media such as computer disks, Compact Disks (CDs), Digital Video Disks (DVDs), to name a few. With the advent of the Internet and other wireless communication distribution mechanisms intellectual property protection has become a major concern. The CD, DVD, computer files, programs and other digital medium use common standards for the digital recording and storage of data, software, photos, videos, and audio. Additional media, such as large super density disks for notebook and hand held PC's, and wireless telephones, are making considerable gains in the software and data distribution market.

The advent of the recent popularity in the digital format used by various intellectual property owners has also resulted in a number of various copy protection systems and methods. These are generally grouped in categories such as encryption, copy protection, and content extensions.

Prior art methods of preventing unauthorized copying of copyrighted and protection have varied but do not attain a particularly high degree of protection and/or acceptance. None have incorporated the use of Keystroke Dynamics or any other form of biometric technology. Keystroke dynamics is the least intrusive way of incorporating copy protection of intellectual property.

The process of identifying an individual by their typing rhythm or how the push keys, has been shown to be an effective method by the RAND corporation backed in a study funded by the National Science Foundation in 1980. RAND Report Number R-2526-NSF May 1980. This invention incorporates keystroke dynamics into an intellectual property protection key and thus protects the illegal or unauthorized use of the intellectual property.

Encryption, which is has been around for a long time is used in the digital and analog formats and basically scrambles the information. The intellectual property can be made usable only with the proper intellectual property key being provided. Many of these intellectual property schemes that use encryption have been found that they are easy to crack or circumvent. Once a person who wishes to pirate the intellectual property has obtained the key, the information may be freely duplicated and copied without encryption. Using keystroke dynamics, only the rightful owner of the intellectual property can gain access to the property.

Various intellectual property protection schemes for software were widely used during the early days of the personal computer. The manufacturers of software basically stopped using intellectual protection schemes once they discovered that virtually all intellectual property protection schemes would be quickly broken by hackers and many users complained of their complex schemes. The development of new types of intellectual property protection was also becoming prohibitively expensive. Ultimately intellectual property that was not protected soon become so widely used that at the additional sales could largely make up for the bootleg losses.

Major developers of software programs today use a system in which an installation key is shipped with the original program packaging of the digital media such as DVDs CDs, or floppy diskettes. This installation key is required before the program can be installed or used on a PC. It is very easy to copy the key together with the digital data content of the CD, DVD or floppy diskettes any number of times. This can result in distribution and circulation a large number of pirated (stolen intellectual property) copies.

Other established intellectual property protection schemes allow preventing copying in general with the aid of special formatting or protocol conventions. Such formatting and protocols have been established in the audio and video application of digital playback and recording devices. CDs and digital tape data formats are basically identical and, accordingly, multi-generation copying can be made possible. In a digital recording system, the media to be copied is queried for special copy protection information. If this intellectual property protection is activated, the digital recorder will not allow copying of the data, which in turn prevents the illegal recording or copying of the protected intellectual property. This method, however, is difficult and costly to implement. The required copy protection circuitry must be included in the recording hardware and adds additional manufacturing costs to the product. These types of systems are relatively easy to defeat with devices such as black boxes that filter out the intellectual property protection instructions, from the digital storage media and the methods to defeat these types of protection schemes are widely available. The use of modern PCs makes it possible to easily manipulate such intellectual property protection schemes and to circumvent them.

Even though the process is illustrated with flow charts and diagrams and described herein as embodied in an intellectual property protection system and method, it is not intended to be limited to the details shown. Various modifications and software changes may be made therein without departing from the spirit of the invention and within the scope and range of equivalents of the claims.

The operation of the this intellectual property protection system, together with additional objects and advantages are best understood from the following description of specific embodiments when read in connection with the accompanying drawings.

By this methodology, a user who would try to use an unauthorized piece of intellectual property would not be able to do so, as the inter-timing characteristics of the keystrokes are unique to the owner of the copy protection key. Timing of the keystrokes are gathered and measured by a computer and its input device such as, but not restricted to, a keyboard or keypad. The document, files, software package, or any other intellectual property protected by this type of biometric copy protection could not be re-used or copied by any one who is not authorized. It would require the owner of the intellectual property protection key to allow access, as the owner is the one who has the unique rhythm required to validate the “intellectual property protection key”.

An example of this is:

Intellectual Property Protection Key:

AQ12 3WOR 98

Keystroke timing:

Time between the characters A & Q is: 3 milliseconds.

Time between the characters Q & 1 is: 1 millisecond.

Time between the characters 1 & 2 is: 0.5 millisecond.

Time between the characters 2 & 3 is: 0.25 millisecond.

Time between the characters 3 & W is: 1.5 milliseconds.

Time between the characters W & 0 is: 0.25 millisecond.

Time between the characters 0 & R is: 0.35 millisecond.

Time between the characters R & 9 is: 0.25 millisecond.

Time between the characters 9 & 8 is: 0.5 millisecond.

With the timing as part of the “intellectual property protection key”, an imposter would have to know both the key and be able to replicate the typing rhythm of the individual, who owns the key, in order to copy or modify a protected intellectual property using this method. (SEE FIG. 5.)

With the creation of an intellectual document or property, the keystrokes of the creator can be captured during the creation process. (SEE FIG. 6) This will embed an ownership signature within the context of the text. As each individual has their own unique rhythm, it can be incorporated in to the intellectual property, message or document as it is being created and then verified at some later date by requiring the individual to type in various phrases and/or characters that are contained within the intellectual property protection key, message or document

Intellectual property is defined as: computer software, written material, musical material, video or motion picture material, digital files, or any other document or material that is deemed to be classed as “intellectual property.”

### BACKGROUND OF THE INVENTION

### TECHNICAL FIELD

This invention relates to intellectual property prevention. More specifically, this invention pertains to a method of combining keystroke dynamics (a biometric technology) for protecting intellectual property from unauthorized copying and use.

Intellectual property protection has become popular carriers for various types of information. Software, audio and video information are widely available on various storage media and devices such as CDs (Compact Disks), DVDs (Digital Video Disks), DAT (Digital audio Tape), and other recording media. Most recently, MP3 files have gained in distribution share. These various media and files use common standards for the recording of these various forms of intellectual property. With the explosion of the Internet, the unauthorized sharing and distribution of intellectual property has become rampant. The quality of the digital format of intellectual property compared to the earlier poorer quality analog format makes the intellectual property more prone to unauthorized copying and distributing.

The copying of today's digital intellectual property does not lead to any loss of quality in the data. Each copy produced is as good as the original. Whereas the copying of analog intellectual property is limited in number of quality copies that can be produced. This is due to many factors such as signal to noise ratios that are passed on from copy to copy. Also analog intellectual property will deteriorate over time, whereas digital intellectual property will last much longer.

There have been various protection systems and methods developed over the last few years. Many have used various schemes incorporating encryption and various hardware solutions. Virtually all current methods have been able to be bypassed, as none could incorporate a biometric solution.

The current prior art methods of preventing unauthorized copying of intellectual property have not afforded a very high degree of protection.

Encryption, which is used in protecting intellectual property basically encodes the information so it cannot be read unless the user has the proper key. Many of the existing encryption schemes to date have been found to be easily bypassed. When the individual who wishes to copy the intellectual property knows the key and enters it correctly, the information may be freely copied and regenerated without using encryption.

Intellectual property in the software industry was used during the early days of the personal computing. Software developers and manufacturers stopped using copy protection schemes once it discovered that sophisticated hackers could quickly break virtually all copy protection codes. Manufacturers were also discovering the ongoing development of newer copy protection systems were becoming very expensive. It was also found that non-protected software sales could largely make up for the bootleg losses.

Today, many software programs use an intellectual property protection system that ships an installation key with the original program packaging. Most of these programs are on a CD, DVD, Floppy disk or delivered as a downloadable file from t he Internet. This installation key is required in order to install the software program on a Personal Computer or any other computer system. It is easy to copy the key along with the intellectual property stored on the CD and distribute any number of illegally copies of this intellectual property.

Other established intellectual property protection systems special protocol conventions. Such protocols have been established for CDs DVDs, and DAT recorders. In these types of systems the intellectual property that is to be copied is queried for special copy protection information, and if the protection is activated, the recording devices are not authorized for copying. This method is not advantageous as a high degree of engineering and operation knowledge of recording devices is necessary. Special anti-copy circuitry must be included in the recorder and adds additional costs to the product. These types of systems are known as SCMS. (Serial Copy Management System) This type of protection scheme has many publications showing how to defeat this type of system by using black boxes and other software programs that are freely available on the Internet. The use of modern Personal Computers running these various software programs make it possible to circumvent these copy protection schemes.

A prior art copy protection system is described, for instance, in U.S. Pat. No. 6,397,333. In this application they are using non-biometric “private and public” keys. The problem with this is it does not specifically tie the key owner to the Intellectual property. If a stranger gets the key, then they will be able to replicate the user. This method cannot specifically tie the owner to the property. It assumes that the person entering the “private key” is actually the owner. This method also requires sending the key to the content provider.

### SUMMARY OF THE INVENTION

The object of the invention is to provide an intellectual property protection method and system, which overcomes the previously mentioned disadvantages of existing intellectual property protection devices and schemes currently available which currently protect against the copying of intellectual property/data from one medium onto another storage medium. Identical use of copied intellectual property that was on the original storage medium will not be allowed with this new invention.

This keystroke dynamic methodology is a particular way to prevent the access and reading of intellectual property information and the ultimate copying of the protected intellectual property or data. This process is also one method to prevent copying protected intellectual property form one form of media to another form of media of the same type of different type. (eg, CD, DVD, Zip disks, and any other media storage devices.) This type of system makes the protected intellectual property and data on the storage media unable to be recorded or copied unless authorized by the owner.

With the previous discussion in accordance with the invention, this method of preventing unauthorized copying or duplication of intellectual property, comprises of the following:

developing a unique keystroke dynamic (biometric) identification key for protecting the intellectual property and supplying it to the owner/provider of the intellectual property;

adding the unique (biometric) keystroke dynamics identification key as an authentication signature to the intellectual property or data set to make that a keystroke dynamically signed intellectual property data set;

allow the copying the protected signed intellectual property data with the unique keystroke dynamic identification key from the intellectual property provider to the appropriate authorized media;

communicate and transport the unique keystroke dynamic identification key of the intellectual property to a host computer;

read the keystroke dynamic intellectual property protection key data with the host computer or personal computer and validating the keystroke dynamic protection key data, to restore and/or use the protected intellectual property data stored in the host computer or personal computer; and

encode the keystroke dynamic intellectual property protection key within the intellectual property on the storage media with the unique keystroke dynamic (biometric) signature to form the protection of the intellectual property;

An additional feature of the invention is the authentication and protection process of the keystroke dynamic intellectual property protection signature and how it is formed from the unique keystrokes that are gathered during the keystroke dynamic intellectual property protection key definition phase. SEE (FIG. 1) In the case of software protection, as an example, the manufacturer would supply an installation key to the owner, as is the current practice within the software industry today. During the installation process the intellectual property key, using keystroke dynamics, would be generated by asking the owner to enter the supplied key a number of times during the Installation process. The algorithms would know how many characters would be required in order to bind the user to the signature created and thus only the user could use the installation key.

Another feature of the invention, the keystroke dynamically generated protection key is checked by the system and, if the keystrokes dynamics signature is authenticated by the system and the keystroke dynamic intellectual property key does not match the unique keystroke dynamically generated key of the intellectual property, any output or use of the intellectual property accessed by the host computer or personal computer is blocked.

Also provided in this invention is a keystroke dynamic intellectual property protection system, comprising:

a piece of intellectual property having a unique keystroke dynamic identification key and having an input for receiving the keystroke dynamic identification key formed from keystroke dynamic identification key creation routine and the unique keystroke identification key;

a program or routine used in the intellectual property storage media for authenticating the signed intellectual property data as authorized data, for storing this intellectual property data set in the storage media, and for encoding the intellectual property data set with a given keystroke dynamic intellectual property protection key to form fully protected intellectual property data;

a personal computer or other host computer connected to the storage system, the personal computer or host computer receiving the protected intellectual property data from the storage media, unlocking the protected intellectual property data, and processing the protected intellectual property data set.

Another feature of the invention, is the capability of defining the keystroke dynamic intellectual property protection key that any user could use.

This invention also describes a method in which the storage media that contains the intellectual property that is to receive intellectual property for storage monitors the authorization of the data set to be written by way of a keystroke dynamic signature, before the intellectual property on the storage media is released for copying or other uses. This signature checking is combined with the data stored, so that only authenticated data is accessed or delivered, in a readable form, from the storage media to the requesting person or system.

A part of the keystroke dynamic intellectual property protection key may be visible to any user, but only the owner can actually unlock the keystroke dynamic intellectual property for copying and or re-distribution purposes.

The program authenticates the intellectual property data set by way of the inputted keystroke dynamic intellectual property key against its recorded/stored keystroke dynamic intellectual property key. The keystroke dynamic intellectual property protection key that is input must correspond to a recorded/stored keystroke dynamic protection key of the intellectual property. The system allows writing of only that data that has been provided with the valid/authenticated signature. The signature is established by the owner and is distributed as follows;

The keystroke dynamic intellectual property protection key of the media is communicated to the owner of the intellectual property.

The owner of the intellectual property establishes the keystroke dynamically required signature (intellectual property protection key) with the signature creation function which contains the following parameters; (See FIG. 1)

an authorization or intellectual property key;

a routine that gathers the keystrokes and creates the keystroke dynamic signature/key to protect the intellectual property, based on keystroke dynamic methodologies; and

the intellectual property has this keystroke dynamics signature embedded into it and is considered to be signed by the rightful owner.

The user's system receives the keystroke dynamic intellectual property protection key and checks the stored signature. The system will release the protected property for use only upon the successful checking and authorizing of the signature. (SEE FIG. 3) The individual or host is allowed to process only that data that has been authorized by using the appropriate algorithms. Data that was not authorized will not be available or usable by the individual or host.

The keystroke dynamic intellectual property protection key that is stored “straight” or “encrypted” in the media containing the intellectual property and may or may not be encrypted for security reasons. (SEE FIG. 2)

Copying of a keystroke dynamic protected intellectual property from media with this keystroke dynamic protection method to media in which this type of protection methodology is not implemented can be done. However, the protected intellectual property is not useable because the keystroke dynamic protection key travels with the data and another user would not have the same keystroke dynamics as the original owner.

In summary, this invention is a combination of a keystroke dynamic created signature with an embedding method, which uses variable parameters. This achieves the protection of intellectual property that is owned by the original owner(s) and this intellectual property can only be read or accessed by the rightful owner or authorized person/host. Copying of the keystroke dynamic protected intellectual property is useless, because the intellectual property is protected with the keystroke dynamic signature of the owner, which is stored within the intellectual property. The result is a simple and cost effective intellectual property protection system, which is far superior and easier to implement than some of the methods described in the background section.

Other features which are considered as part for this invention are set forth in the claims section.

### BRIEF DESCRIPTION OF DRAWINGS

FIG. 1

FIG. 1 lays out the process for developing the BiOmetric Keystroke Dynamic Intellectual Property Protection Key. The following numbers refer to the various steps in regard to developing such a system for this Intellectual Property Protection Key.

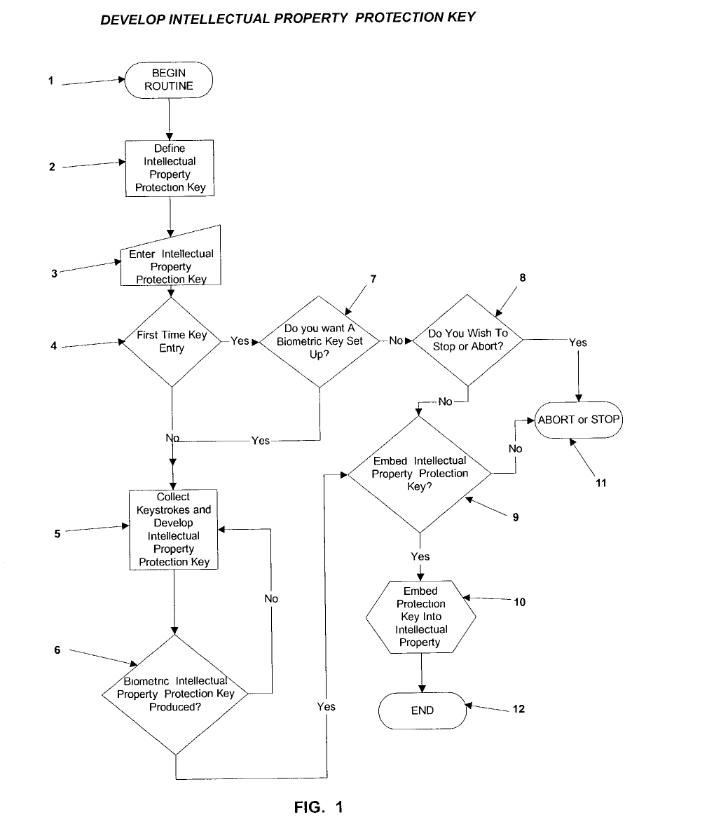

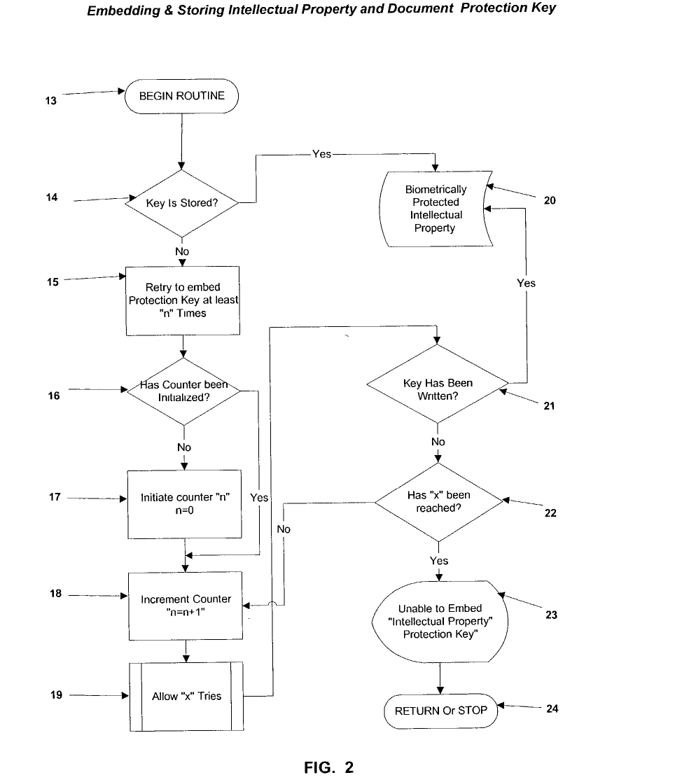

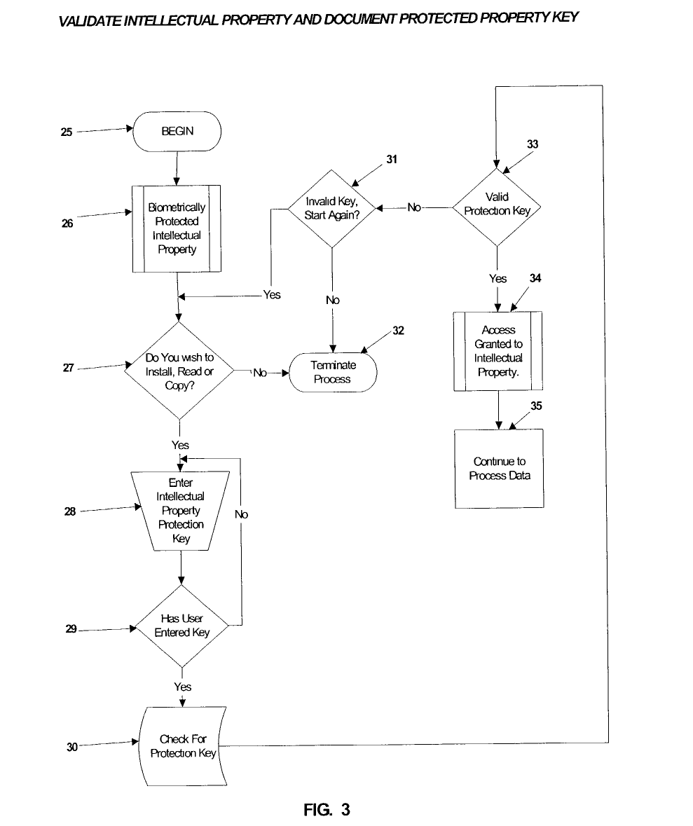

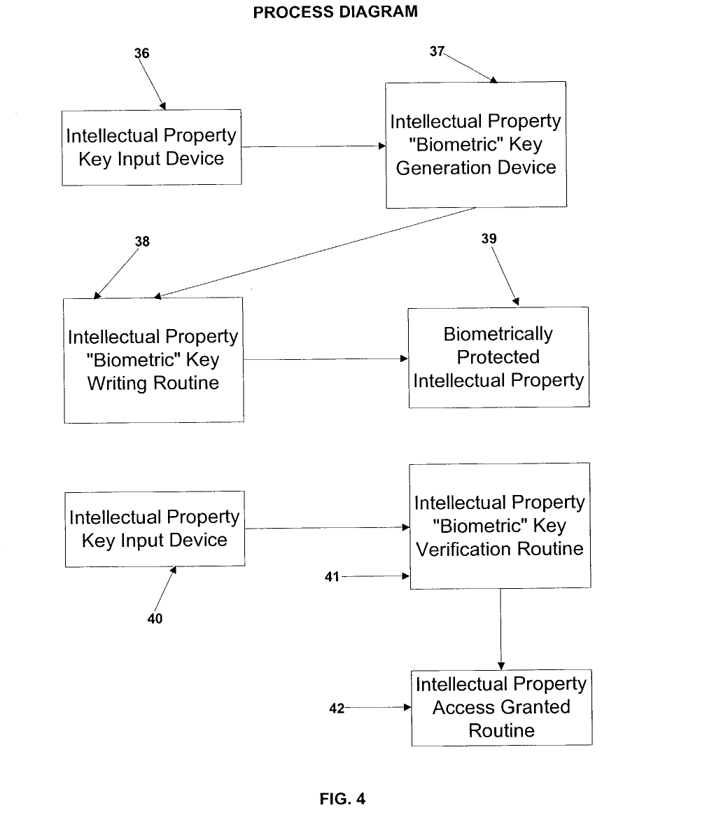

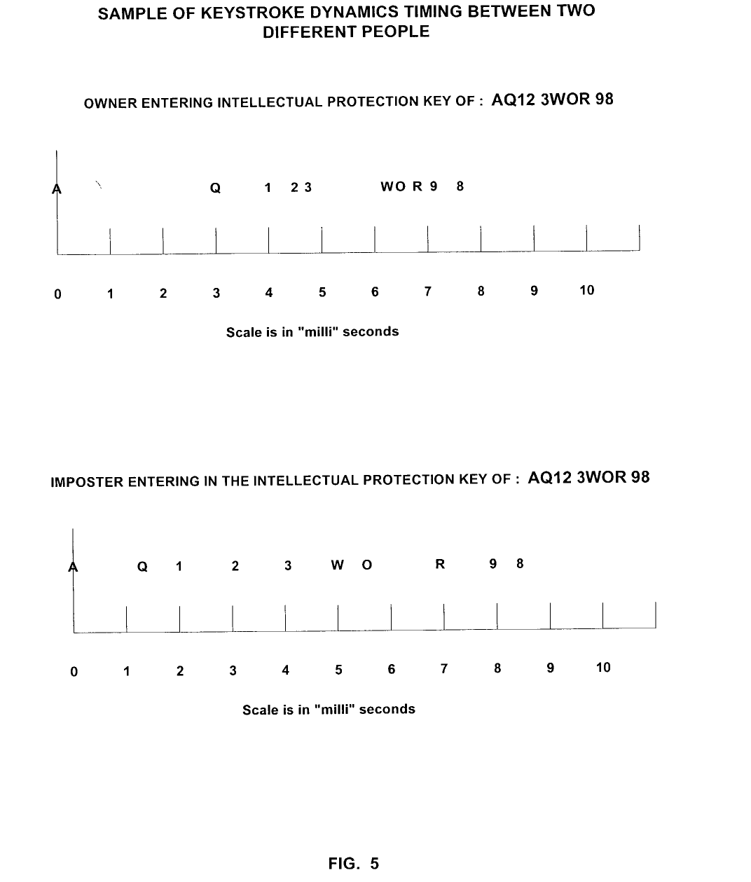

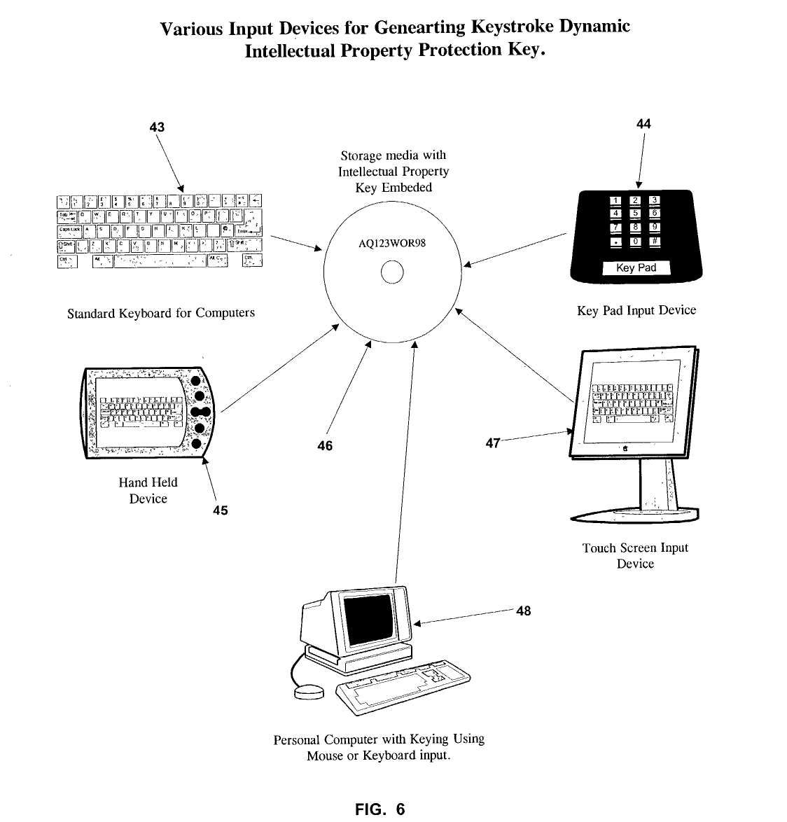

1. Begin the process to develop the biometric intellectual property protection key using keystroke dynamics.

2. Define or ask for the intellectual property or registration key.

3. Enter the intellectual property protection key.

4. Decide if this is the first time the intellectual property key has been entered in the development routine.

5. Keystrokes are input by user using a keying input device and then passes the input through the keystroke dynamic algorithms to produce unique inter-character timing characteristics.

6. After sufficient number of keystrokes have been gathered, the unique biometric keystroke dynamic intellectual property key is produced.

7. Decide whether to set up a standard (non-biometric) intellectual property protection key or a biometrically created intellectual property protection key.

8. Decide whether to continue to develop a standard (non-biometric) intellectual property protection key or quite the intellectual property protection key generation process.

9. Decide whether to embed the intellectual property protection key within the intellectual property that requires this protection.

10. Embed the biometric or standard intellectual property protection key within the intellectual property that requires protection. Intellectual property may be software, electronically produced documents, data, files or any other type of digital media that may be deemed personal or intellectual property.

11. Abort or stop the intellectual property protection key generation process.

12. End of the development process of the intellectual property protection key generation process.

FIG. 2

FIG. 2 lays out the process for storing and embedding the Biometric Keystroke Dynamic Intellectual Property Protection Key within the Intellectual Property. The following numbers refer to the various steps in regards to storing and embedding the protection key in the targeted or identified Intellectual Property.

13. Begin the process to embed and store the biometric intellectual property protection key using keystroke dynamics.

14. Decide whether the intellectual property biometric protection key has been stored.

15. If Intellectual property biometric key has not been stored then re-try some number of times as define by “n” to store intellectual property biometric key.

16. Has the counter “n” been initialized?

17. Initialize counter “n” to zero.

18. Increment counter by 1.

19. All system some number of tries, represented by some numerical value represented by “x”, to write the biometric intellectual property protection key.

20. Created and stored biometric protected intellectual property using keystroke dynamic generated protection key.

21. Has the biometric intellectual property protection key been written and created.

22. Has the number “x” as mentioned in Item number “19” been reached.

23. Notify creator that system was unable to embed the biometric intellectual property key.

24. End or Stop the process to embed and store the biometric intellectual property protection key using keystroke dynamics.

FIG. 3

FIG. 3 lays out the process for validating the rightful owner of the Biometric Keystroke Dynamic Intellectual Property Protection Key. The following numbers refer to the various steps in the validation process to make sure the rightful owner of the Intellectual Property is the person accessing the Intellectual Property.

25. Begin the process to validate us of intellectual property protected by the biometric intellectual property protection key using keystroke dynamics.

26. Obtain a copy of the biometrically protected intellectual property that has been protected by the use of keystroke dynamics.

27. Does the User wish to Install, Read or Copy the biometrically protected intellectual property?

28. Ask User to Enter in Intellectual Property Protection key.

29. Has the Intellectual Property key been entered?

30. Send the Key to be processed for validation.

31. An invalid key has been entered or the key cannot be verified and the user is asked if the wish to try again.

32. Terminate process for allowing access to protected intellectual property.

33. Check to see if this is a Valid Intellectual Property protection Key.

34. Biometric intellectual property protection key has been verified and now allow access to intellectual property.

35. Continue to process data as dictated by the authorized user.

FIG. 4

FIG. 4 is a block diagram showing the various overall processes that are required in this invention. They are meant to be high level and give any user who is knowledgeable in the area of protecting intellectual property, an overall understanding of how this system works, from a high level.

36. Block Diagram indicating the Input Device to use for data input for the Keystroke Dynamic Intellectual Property Protection Code.

37. Block Diagram representing the device and/or routine for generating the Keystroke Dynamic Intellectual Property Protection Key.

38. Block Diagram representing the routine and/or device for writing the Keystroke Dynamic Intellectual Property Protection Key.

39. Block Diagram representing the Keystroke Dynamic Protected Intellectual Property.

40. Block Diagram indicating the Input Device to use for data input for the Keystroke Dynamic Intellectual Property Protection Code.

41. Block Diagram representing the verification routine of the Keystroke Dynamic Intellectual Property Protection Key.

42. Block Diagram showing upon Verification of the correct Keystroke Dynamic Intellectual Property Protection Key, access is granted to the Protected Intellectual Property.

FIG. 5

FIG. 5 is an example of how the same Intellectual Property Key is keyed by and used by two different individuals. One of the individuals is the owner of the key and the other individual is and imposter. The inter-character timing is shown in milli-second on the “X” axis up to 10 milliseconds as measured by the process. As can be seen, there is a difference in timing characteristics between the actual owner of the Key and the other individual (the imposter) who is trying to use the owner's key. As the Imposter's timing differs from the actual owner of the key, the system will deny the Imposter access to the intellectual Property.

FIG. 6

FIG. 6 shows some of the various devices that can be used to input and generate the appropriate Biometric Intellectual Property Key using keystroke dynamics. These devices all have an associated alpha or numeric keying input device associated with them. This diagram is an example of, but not limited to, various devices that are available to use for a keystroke dynamics generated Intellectual Property Protection Key.

43. Visual representing an example of a keyboard used for the input of characters that are used for the creation of the Keystroke Dynamic Intellectual Property Protection Key.

44. Visual representing an example of a keypad used for the input of characters that are used for the creation of the Keystroke Dynamic Intellectual Property Protection Key.

45. Visual representing an example of a hand held device used for the input of characters that are used for the creation of the Keystroke Dynamic Intellectual Property Protection Key.

46. Visual representing an example of storage media that contains intellectual property and the storage of the Keystroke Dynamic Intellectual Property Protection Key.

47. Visual representing an example of a touch screen device used for the input of characters that are used for the creation of the Keystroke Dynamic Intellectual Property Protection Key.

48. Visual representing an example of a computer system used for the input of characters that are used for the creation of the Keystroke Dynamic Intellectual Property Protection Key.

I claim:

1. A method of preventing unauthorized copying/using of intellectual property such as digital data, software programs, files, electronic books, videos, music, or any other form of digital media and any other types copy written material, which comprises:
communicating a unique keystroke dynamic biometric generated protection key of a protected piece of intellectual property to an intellectual property content provider, host or owner;
adding the unique biometric keystroke dynamic protection as a validation and authenticating signature to a piece of intellectual property to form a keystroke dynamically signed piece of intellectual property;
copying the signed piece of intellectual property with a unique keystroke dynamic protection key from the content owner to the intellectual property;
encoding the keystroke dynamic signature key into the intellectual property with the unique keystroke dynamic protection key to form copy protected intellectual data;
communicating this unique keystroke dynamic protection key of the intellectual property to a host computer over a telecommunications network or computer network or any wireless network;
reading of the keystroke dynamic protection key data with a host computer or individual computer or hand held personal communications device and decoding the keystroke dynamic identification key data to allow use of the biometrically protected intellectual property that may be resident on the host computer, individual computer, or hand held personal communications or any other storage device;
Storage device may be any media that, in the past, present or future that is capable of storing digital data and allows the reading of that data.

2. The method according to claim 1, which comprises forming the keystroke dynamic authenticating signature from the unique keystroke dynamic identification, and following the copying step, checking the unique keystroke dynamic identification signature that is resident within the protected intellectual data set with the rightful owners keystroke dynamic identification key against a keystroke dynamic identification key present in the Intellectual property or database.

3. The method according to claim 1, which comprises checking the keystroke dynamic identification signature data signature in the intellectual property and, if the authenticating of the keystroke dynamic signature in the signed intellectual property does not match the unique keystroke dynamics identification signature of the intellectual property, blocking any use of the intellectual property is implemented by the host or person.

4. An intellectual protection system, comprising:
a piece of intellectual property having a unique keystroke dynamic protection key and having an input mechanism for receiving signed intellectual property formed from such a keystroke dynamic template and the unique identification;
a method in said intellectual property for authenticating the signed intellectual property as authorized property, for storing the keystroke dynamic protection key set in said intellectual property, and for encoding the intellectual property with a given keystroke dynamic protection key to form copy protected data;
a host system or computer connected to said intellectual property, said host system or computer receiving the keystroke dynamic protected data from said intellectual property, unlocking the protected intellectual property data, and processing the protected intellectual property;
an input method using a keyboard, keypad, touch screen or any other input device that can be used to generate an alphanumeric keystroke dynamically generated intellectual property protection key.

5. The system according to claim 4, wherein said host includes a keystroke dynamic protection generation routines and a keystroke dynamic protection signature that may be stored in said host and included in the property protection and a signature protection key.

6. The system according to claim 4, which further comprises a keystroke dynamic protection generation routines for generating a keystroke dynamic signature to be included in said given intellectual property protection key.
